(19) United States
(12) Patent Application Publication
(10) Pub. No.: US 2003/0105533 A1
(43) Pub. Date: Jun. 5, 2003

(54) Electrolysis apparatus

(75) Inventors: Tsuyoshi Hirokawa, Shizuoka-ken (JP); Toru Yamazaki, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/309,006

(22) Filed: Dec. 4, 2002

(30) Foreign Application Priority Data
Dec. 5, 2001 (JP) 2001-371958

(51) Int. Cl. G05B 15/00

(52) U.S. Cl. 700/1

(57) ABSTRACT

An object of the present invention is to provide an electrolysis apparatus that can prevent formation of surface defects such as white bands on an obtained aluminum support for a planographic printing plate even when electrolyzing an aluminum strip at a high current density while conveying the aluminum strip at a high conveyance velocity.

The electrolysis apparatus is used for electrolyzing a metal strip conveyed in one direction.

The apparatus includes a plurality of electrolysis cells arranged in series, wherein the metal strip is electrolyzed in an acidic electrolyte by applying an alternating current.

In an electrolysis cell disposed in the downstream-most position with respect to the conveyance direction of the metal strip, electrolysis is carried out at a lower current density than in an electrolysis cell disposed in an upstream electrolysis cell with respect to the conveyance direction.

### BACKGROUND OF THE INVENTION

1. Field of the Invention

The present invention relates to an electrolysis apparatus, especially to an electrolysis apparatus for electrolyzing a metal strip at a high current density while conveying the metal strip at a high conveyance velocity without forming any defects on the surface thereof

2. Description of the Related Art

A planographic printing plate is typically produced by a process including the following steps:

a) roughening one or both sides of an aluminum strip to produce an aluminum support having rough surface(s) on one or both sides;

b) anodizing the aluminum support; and then,

c) applying a solution containing a photosensitive, heat sensitive or photopolymerizable resin on the rough surface of the aluminum support to form an image-forming layer.

The aluminum strip is typically roughened by a process including the following steps:

a) mechanical roughening: scraping mechanically one or both sides of the aluminum strip using a cylindrical rotating brush having polyamide bristles or using a grinding roller having a grinding cloth surface;

b) chemical roughening: etching the scraped surface of the strip in an alkali solution; and then,

c) electrolytic roughening: electrolyzing the etched surface of the strip by using the strip as an electrode.

The electrolytic roughening is performed by applying an alternating current such as a sine wave current, a trapezoidal wave current, or a rectangular wave current to the aluminum strip in the presence of an acidic electrolyte. Therefore, positive and negative voltage is alternately applied to the strip at an entrance of an electrolysis cell.

While the positive voltage is applied, a cathodic reaction occurs on the surface of the strip. On the other hand, when negative voltage is applied, an anodic reaction occurs. When a cathodic reaction occurs, an oxide layer is formed. Contrastingly, when an anodic reaction occurs, the oxide layer resolves into an acidic electrolyte to form honeycomb-shaped pits on the surface of the strip.

However, when electrolyzing an aluminum strip at a higher current density while conveying it at a higher conveyance velocity, many kinds of distinctive surface defects, such as white bands having different densities, chatter marks, which are band-like defects running in the width-direction of the support, and stripes running in the width direction there is sometimes formed on the surface of an obtained aluminum support are sometimes formed on the surface of an obtained aluminum support.

### SUMMARY OF THE INVENTION

Accordingly, an object of the present invention is to provide an electrolysis apparatus that can prevent formation of surface defects, such as white bands, on an obtained aluminum support even when electrolyzing at a higher current density while at the same time conveying an aluminum strip at a higher conveyance velocity.

A first aspect of the present invention for achieving the aforementioned object relate to an electrolysis apparatus for electrolyzing a metal strip conveyed in one direction, the apparatus comprising a plurality of electrolysis cell arranged in series, wherein: the metal strip is electrolyzed in an acidic electrolyte by applying an alternating current; electrolysis is carried out at an electrolysis cell located at a most downstream position, with respect to the conveyance direction, at a lower current density than at an electrolysis cell located upstream, with respect to the conveyance direction, from said most downstream electrolysis cell.

The inventors have found that when electrolyzing a metal strip using an electrolysis apparatus having a plurality of electrolysis cells, surface defects are more likely formed when applying alternating current of higher current density to the downstream-most electrolysis cell.

In the electrolysis apparatus of the first aspect, a metal strip is electrolyzed at a high current density in the electrolysis cell positioned in an upstream position, while the metal strip is electrolyzed at a lower current density in an electrolysis cell located in a downstream position. Therefore, alternating current of a higher current density can be applied to the electrolysis apparatus as a whole while the metal strip is carried at a higher conveyance velocity, and the metal strip is electrolyzed efficiently without forming any surface defects.

Herein, “current density” means a mean current density of the alternating current applied to an electrolysis cell.

The electrolysis apparatus of the first aspect includes an apparatus for electrolytically roughening an aluminum strip but is not limited thereto.

The electrolysis performed in the apparatus of the present invention includes electrolytic roughening of an aluminum strip but is not limited thereto.

The aforementioned aluminum strip is an example of the metal strip used in the present invention. The metal strip is not limited to aluminum and examples of the metal strip may include strips formed of other metals.

A second aspect for achieving the aforementioned object relates to an apparatus of the first aspect wherein the metal strip is an aluminum strip.

When electrolyzing an aluminum strip at a higher current density while conveying it at a higher conveyance velocity, white bands of different densities, chatter marks, and other kinds of surface defects are apt to appear on a surface of the aluminum strip. However, as provided by the second aspect, by employing the electrolysis apparatus of the present invention for electrolytic roughening of the aluminum strip, this problem can be readily avoided. Therefore, by using the apparatus of the present invention, an aluminum support for a planographic printing plate can be produced at a higher level of productivity without forming any surface defects.

A third aspect for achieving the above-mentioned object relates to an electrolysis apparatus of the second aspect wherein the acidic electrolyte contains as a principal acid component at least one acid selected from the group consisting of sulfuric acid, nitric acid, hydrochloric acid, phosphoric acid and a sulfonic acid.

The third aspect provides specific examples of the acidic electrolyte that is used in the apparatus of the present invention. Examples of acidic electrolyte include not only a solution containing one of an organic or an inorganic strong acid selected from sulfuric acid, nitric acid, hydrochloric acid, phosphoric acid, and a sulfonic acid, but also a solution containing two or more of the strong acids mentioned above. The acidic electrolyte may also contain an ion of the metal consisting the metal strip; such as aluminum ion, in addition to the aforementioned organic or inorganic strong acids.

A fourth aspect for achieving the aforementioned object is the electrolysis apparatus of the second aspect, wherein the alternating current is a sine wave current, a trapezoidal wave current or a rectangular wave current.

The trapezoidal wave current or the rectangular wave current may contain some ripple. In addition, direct current can be overlapped over the aforementioned alternating current.

A fifth aspect for achieving the aforementioned object is the electrolysis apparatus of the second aspect wherein the electrolysis cells are vertical electrolysis cells, horizontal electrolysis cells, or radial electrolysis cells.

A sixth aspect for accomplishing the above-mentioned object is the apparatus of the fifth aspect having at least two electrolytic cells and the ratio of the current density at an upstream cell to the current density at a down stream cell is from 1.2:1 to 2:1.

By setting the current densities at the upstream cell and the downstream cell so that these two current densities are in the ratio provided above, formation of surface defects can be effectively further prevented in cases when treatment of the aluminum strip is at a higher current density while the conveyance is at a higher conveyance velocity.

A seventh aspect for achieving the aforementioned object relates to the electrolysis apparatus of the fifth aspect wherein the current density at the downstream electrolysis cell is 15 to 30 A/dm².

If the current density at the downstream electrolysis cell is set to within the above-mentioned range, formation of surface defects can be effectively prevented.

An eighth aspect for achieving the aforementioned object relates to the electrolysis apparatus of the fifth aspect, wherein the apparatus has three or more electrolysis cells.

By using the apparatus of the present aspect, the aluminum support having no surface defects can be produced both at a higher current density and at a higher conveyance velocity.

In the electrolysis cells located from a most upstream position through a second-most downstream position, current density can be set equally to a value of MC_{A}, while current density in the electrolysis cell at the most downstream can be set to a value of MC_{B}, which is lower than MC_{A}.

On the other hand, when an alternating current of current density MC₁ is applied to one electrolysis cell and an alternating current of current density MC₂ is applied to an electrolysis cell adjacent to and downstream from the one electrolysis cell, current density MC₂ can be set to be lower than current density MC₁.

A ninth aspect for achieving the aforementioned object relates to the electrolysis apparatus of the eighth aspect wherein the density in an electrolysis cell is MC₁, the current density at an electrolysis cell adjacent to and located downstream from one of said electrolysis cells is MC₂, and the current density MC₂ is lower than current density MC₁.

By setting the current density in the apparatus of the eighth aspect as mentioned above, the aluminum strip can be conveyed at a higher conveyance velocity and an aluminum support free from surface defects can be produced at a higher current density.

A tenth aspect for achieving the aforementioned object relates to the electrolysis apparatus of the fifth aspect wherein at least one of the electrolysis cells has a soft-starting portion at an entrance portion thereof from which the aluminum strip is introduced and the soft-starting portion being disposed so that current density increases as the aluminum strip is conveyed farther into the electrolysis cell.

In the above-described electrolysis cell, the current density is the lowest at the entrance portion and the further the aluminum strip is conveyed into the cell, the larger the current density becomes. Therefore, a high current density is not suddenly applied to the aluminum strip at the entrance of the electrolysis cell, and generation of surface defects caused by sudden application of a high current to the aluminum strip can be effectively prevented.

An eleventh aspect for achieving the aforementioned object relates to the electrolysis apparatus of the tenth aspect wherein the current density at said soft-starting portion at the entrance portion is 10A/dm² or less.

A twelfth aspect for achieving the aforementioned object relates to the electrolysis apparatus of the tenth aspect, wherein the current density at said soft-starting portion at the entrance portion is in a range of from 1 to 5 A/dm².

By setting the current density in the above-mentioned range at said soft-starting portion at the entrance portion, generation of said surface defect can be effectively prevented.

A thirteenth aspect for achieving the aforementioned object relates to the electrolysis apparatus of the tenth aspect wherein said soft-starting portion is formed having a length L calculated according to the following equation:

MC×LS/L=50 to 300

wherein LS is a conveyance velocity at which the aluminum strip is conveyed through the electrolysis cell and MC is the current density at the electrolysis cell.

By determining the length of the soft-starting portion according to the above equation, the length of the soft-starting portion is optimized in accordance with the conveyance velocity of the aluminum strip and the current density of the electrolysis cell. Therefore, it is most efficient for the soft-starting portion to have the length L.

A fourteenth aspect for achieving the aforementioned object relates to the electrolysis apparatus of the tenth aspect wherein the soft-starting portion is an asymptotic portion formed at the entrance portion of an electrode of the electrolysis cell, and at which the electrode applies alternating current to the conveyed aluminum strip; said asymptotic portion being formed so as to approach, along the conveyance direction, the conveyance surface on which the aluminum strip is conveyed.

The larger the distance between the electrode and the conveyance surface, the lower is the current applied to the aluminum strip conveyed on the conveyance surface becomes. Therefore, by providing an asymptotic portion at the entrance portion of the electrolysis cell, current density can be continuously increased from a lower value to a predetermined value.

The conveyance surface is a hypothetical surface on which the aluminum strip is carried.

A fifteenth aspect for achieving the aforementioned object relates to the electrolysis apparatus of the tenth aspect wherein said electrode is a split-type electrode comprising a group of small electrodes insulated from each other; and said soft-starting portion is formed by connecting a current reducer to the small electrodes located at the entrance portion of the electrolysis cell.

In the above apparatus according to the present aspect, a current reducer is interposed between power source and a small electrode located at the entrance, and an intensity of the alternating current applied to the small electrode can be reduced. Therefore, the current reducer can reduce the current density applied to the small electrode.

When a current reducer having a higher resistance or impedance is connected to a small electrode, the current density at the small electrode is lower. On the other hand, when a current reducer having a lower resistance or impedance is connected to a small electrode, the current density at the small electrode is higher.

Therefore, the soft-starting portion also can be formed by connecting one or more reducer(s) having a higher resistance or impedance to small electrodes at the entrance portion of the electrode in an electrolysis cell and connecting one or more reducer(s) having a lower resistance or impedance to small electrodes at the inside portion of the electrode.

Thus, by connecting a current reducer to a small electrode, the soft-starting portion can be formed. The current intensity applied to the electrode can be adjusted by connecting a current reducer having a different resistance or impedance.

A sixteenth aspect for achieving the aforementioned object relates to the electrolysis apparatus of the fifteenth aspect wherein said current reducer is selected from a group of a resistor and an inductance coil.

### BRIEF DESCRIPTION OF THE DRAWINGS

FIG. 1 is a longitudinal sectional view of an electrolysis apparatus according to a first embodiment.

FIG. 2 is a longitudinal sectional view of an electrolysis apparatus according to a second embodiment.

### DETAILED DESCRIPTION OF THE EMBODIMENTS

A First Embodiment

An apparatus for electrolytic roughening 100 according to a first embodiment of the present invention, which apparatus has two electrolysis cells will now be described.

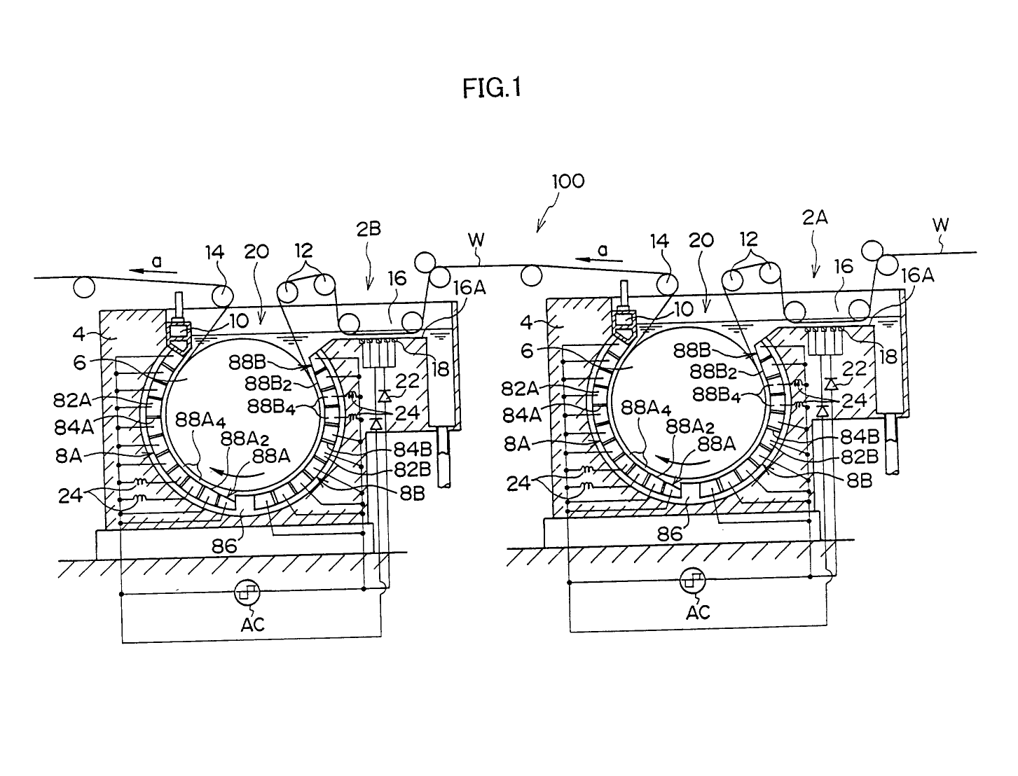

FIG. 1 shows a construction of the apparatus for electrolytic roughening 100.

As shown in FIG. 1, an apparatus for electrolytic roughening 100 has electrolysis cell 2A located at an upstream position with respect to a conveyance direction of an aluminum strip W, and an electrolysis cell 2B located at a downstream position with respect to said conveyance direction.

Each of the electrolysis cells 2A and 2B have a main cell 4 containing an acidic electrolyte, and a conveyance roller 6 disposed horizontally in the main cell 4 and rotating clockwise around an axis thereof to convey the aluminum strip W.

Each of the main cells 4 has a substantially cylindrical inner wall and electrodes 8A and 8B, having a half-cylinder shape, are provided on the inner wall so that the electrodes 8A and 8B surround the conveyance roller 6.

The electrodes 8A and 8B are split electrodes each of which include a group of small electrodes 82A and 82B, respectively, and each of which also include insulators 84A and 84B, respectively. The insulators 84A are interposed between adjacent small electrodes 82A, and the insulators 84B are interposed between adjacent small electrodes 82B.

The small electrodes 82A and 82B can be formed from a graphite, a metal, or the like, while the insulators 84A and 84B can be made of a polyvinyl chloride resin or the like.

A thickness of the insulators 84A and 84B is preferably 1 to 10 mm.

In both of the electrodes 8A and 8B, each of the small electrodes 82A and 82B is connected to a power supply AC. The small electrodes 82A and insulator 84A, and the small electrodes 82B and the insulators 84B are respectively held by one of electrode holders 86 formed from an insulating material to respectively form electrodes 8A and 8B.

The power supply AC applies alternating current to the electrodes 8A and 8B.

Examples of power supply AC include a sine wave generating device, which generates a sine wave by transforming a current and a voltage of an alternating current of a commercial frequency using an inductance regulator and a transformer; and a thylister device, which generates a trapezoidal or rectangular current from a direct current rectified from an alternating current of a commercial frequency.

At a top of each of electrolysis cells 2A and 2B, there is an opening 20 through which the aluminum strip W is introduced into and drawn out of the electrolysis cells 2A and 2B. At each of the opening 20, an acidic electrolyte supplying conduit 10, from which an acidic electrolyte is supplied to the main cell 4, is provided close to the end of a downstream electrode 8A with respect to the conveyance direction a. A nitric acid solution, a hydrochloric acid solution, or the like can be employed as the acidic electrolyte.

Over each of the electrolysis cells 20A and 20B, and in proximity to each of the openings 20, there are upstream guide rollers 12, which are a group of rollers introducing the aluminum strip W into the electrolysis cell 20A or the electrolysis cell 20B and downstream guide rollers 14 guiding the aluminum strip W out of the electrolysis cell 20A or the electrolysis cell 20B.

In each of the electrolysis cells 2A and the electrolysis cells 2B, an auxiliary cell 16 is disposed at an upper side of the main cell 4. The auxiliary cells 16 are made shallower than the main cells 4, and each has a flatly shaped bottom 16A. Auxiliary electrodes 18 having a plate-like shape, are disposed at each of the bottoms 16A.

The auxiliary electrodes 18 can be preferably formed of a corrosion resistant metal, such as platinum, ferrite, or the like.

The auxiliary electrodes 18 are connected, respectively, to the power supply AC in parallel with the electrodes 8B. Diodes 22 are interposed between the power supply AC and the auxiliary electrodes 18 so that electric current flows in a direction from the power supply AC to the auxiliary electrodes 18.

Soft-starting portions 88A and 88B are respectively formed at the upstream end of the electrodes 8A and 8B.

The soft starting portions 88A and 88B have asymptotic portions 88A₂ and 88B₂, respectively, and have interposed portions 88A₄ and 88B₄, respectively. The asymptotic portions 88A₂ and 88B₂ are shaped so that they approach the surface of the conveyance roller 6 along the conveyance direction. The interposed portions 88A₄ and 88B₄ are located at positions downstream from the asymptotic portions 88A₂ and 88B₂, respectively, and inductance coils 24 are interposed between the power supply AC and both the inductance interposed portions 88A₄ and 88B₄.

A current density of an alternating current applied to the electrodes 8A and 8B of the electrolysis cell 2A is higher than that of an alternative current applied to the electrodes 8A and 8B of the electrolysis cell 2B. Preferably, the former is 1.2 to 2 times higher than the latter.

The current density of the alternating current applied to the electrodes 8A and 8B of the electrolysis cell 2B is preferably 15 to 30 A/dm².

Operation of electrolytic roughening apparatus 100 will now be described.

The aluminum strip W, which is guided from the right in FIG. 1 into the electrolysis cell 2A is first introduced into the auxiliary cell 16. In the auxiliary cell 16, an anode reaction occurs on the surface of the aluminum strip W. Then, the aluminum strip W is guided by the upstream guide roller 12 and introduced into the main cell 4.

In the main cell 4, the conveyance roller 6 conveys the aluminum strip W in the conveyance direction a. At first, the aluminum strip W passes by the soft-starting portion 88B. At the upstream end of the soft-starting portion 88B, an alternating current of a current density much lower than a current density MC_{A} is applied to the aluminum strip W. While the aluminum strip W is carried downstream in the main cell 4, the current density increases. At the downstream end of the soft-starting portion 88B, the current density is equal to MC_{A}.

After passing the soft-starting portion 88B, the aluminum strip W is carried along the electrode 8B and an anode or cathode reaction takes place on the surface of the aluminum strip facing the electrode 8B.

After being carried along the electrode 8B, the aluminum strip W passes by the soft-starting portion 88A. At the soft-starting portion 88A, as well as the soft-starting portion 88B, an alternating current of a current density much lower than MC_{A} is applied to the aluminum strip W While the aluminum strip W is carried downstream, the current density increases and at the downstream end of the soft-starting portion 88A, the current density is also equal to MC_{A}.

After passing by the soft-starting portion 88A, the aluminum strip W is carried along the electrode 8A and an anode or cathode reaction occurs on the surface of the aluminum strip W facing electrode 8A which results in the formation of honeycomb-shaped pits on the whole surface of the aluminum strip W.

After being electrolytically roughened, the aluminum strip W is guided by the downstream guide rollers 14 so as to be guided out of main cell 4 of the electrolysis cell 2A.

After being guided out of electrolysis cell 2A, the aluminum strip W is the guided into electrolysis cell 2B.

At the electrolysis cell 2B, the aluminum strip W is introduced into the auxiliary cell 16 in order to be anodized.

Then, the aluminum strip W is introduced into the main cell 4 by the upstream guide rollers 12. In the main cell 4 of the electrolysis cell 2B, at the upstream ends of the soft-starting portions 88A and 88B, an alternating current of a current density much lower than current density MC_{B} in the electrolysis cell 2B is applied to the aluminum strip W. At the downstream ends of the soft-starting portions 88A and 88B, the current density is equal to the current density MC_{B}. While being conveyed along portions of the electrodes 8A and 8B downstream from the soft-starting portions 88A and 88B, the aluminum strip W is electrolytically roughened at a current density of MC_{B}.

The current density MC_{B} at the electrolysis cell 2B is lower than the current density MC_{A} at the electrolysis cell 2A. Preferably, the current density MC_{B} is in the range of from MC_{A}/1.2 to MC_{A}/2.

After passing through the main cell 4 of electrolysis cell 2B, the aluminum strip W is guided out by the downstream guide rollers 14.

In the electrolytic roughening apparatus 100 of the first embodiment, the aluminum strip W is roughened in the downstream-most electrolysis cell 2B at a current density that is 1/1.2 to 1/2 of the current density at the electrolysis cell 2A located in an upstream position. Therefore, surface defects mentioned in the ‘Description of the Related Art’ are particularly unlikely to be formed.

Additionally, the soft-starting portions 88A and 88B are provided in the main cell 4 of each of the electrolysis cells 2A and 2B, and therefore, alternative current having a lower current density than MC_{A} or MC_{B}, which are the current densities of the alternating current applied to the main cell 4, is applied to the aluminum strip W at the entrance of main cells 4. Accordingly, when the aluminum strip is conveyed at a higher conveyance velocity and roughened at a higher current density, there is no generation of surface defects, such as chatter marks, and honeycomb-shaped pits are uniformly formed on the whole of the roughened side of the aluminum strip W.

A Second Embodiment

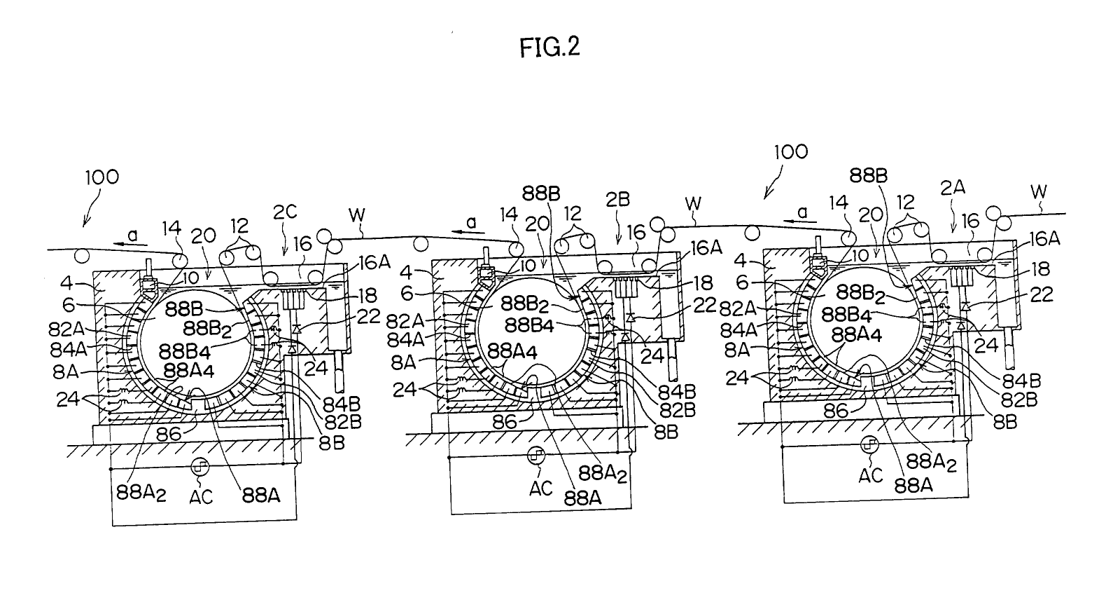

FIG. 2 shows an electrolytic roughening apparatus 102 having three electrolytic cells, according to the second embodiment of the present invention.

As shown in FIG. 2, the electrolytic roughening apparatus 102 has the same composition as that of the electrolytic roughening apparatus 100 found in the first embodiment, except that electrolysis cell 2C, which has the same composition as that of the electrolysis cell 2B, is disposed in a downstream position from the electrolysis cell 2B.

The current density MC_{B} in the electrolysis cell 2B can be set lower than the current density MC_{A} in the electrolysis cell 2A. The current density MC_{C} in the downstream-most electrolysis cell 2C can be set lower than the current density MC_{B}. Both of the ratios of MC_{A}/MC_{B} and MC_{B}/MC_{C} are preferably from 1.2/1 to 2/1.

On the other hand, the current density MC_{A} can be set equal to the current density MC_{B} and the current density MC_{C} can be set lower than the current density MC_{B}. The ratio of MC_{B} to MC_{C} is preferably from 1.2/1 to 2/1.

### EXAMPLES

### Examples 1 to 3 and Comparative Examples 1 and 2

By using an electrolytic roughening apparatus 100 shown in FIG. 1, an aluminum strip W having a width of 1000 m and a thickness of 0.24 mm was electrolytically roughened. Current densities in electrolysis cells 2A and 2B were set as indicated in Table 1.

A surface quality of the aluminum strip W electrolytically roughened in the electrolytic roughening apparatus 100 was evaluated by visually observing the existence of white bands having different densities, chatter marks and stripes on the surface of the roughened aluminum strip W. The results were classified into the following four classes of ‘Excellent’, ‘Good’, ‘Fair’ and ‘Poor’. The results are shown in Table 1.

TABLE 1

| | Current Densities | | | Surface Defects | | |
|---|---|---|---|---|---|---|
| | (A/dm²) | | | White | Chatter | |
| | MC_{A} | MC_{B} | MC_{A}/MC_{B} | Band | Marks | Stripes |
| Ex. 1 | 40 | 20 | 2.0 | excellent | excellent | excellent |
| Ex. 2 | 33 | 27 | 1.2 | excellent | excellent | excellent |
| Ex. 3 | 41 | 19 | 2.15 | excellent | good | good |
| Comp. | 30 | 30 | 1.0 | poor | fair | fair |
| Ex. 1 | | | | | | |
| Comp. | 20 | 40 | 0.5 | good | poor | poor |
| Ex. 2 | | | | | | |

As Table 1 indicates, in Examples 1 to 3, wherein a current density MC_{B} was lower than a current density MC_{A}, almost no white bands, chatter marks and stripes were seen, and the obtained aluminum support had a good surface quality. Specifically, in Ex. 1, wherein MC_{A} was 1.2 to 2 times larger than MC_{B} and the current density MC_{B} was in a range of 15 to 30 A/dm², no white bands, chatter marks, and stripes were seen, and the obtained aluminum support had an excellent surface quality.

On the contrary, in the Comparative examples, Comp. Ex. 1 and Comp. Ex. 2, wherein MC_{B} was equal or larger than MC_{A}, white bands, chatter marks and stripes were clearly or distinctively seen on the surface of the obtained aluminum support, and the aluminum support had a poorer surface quality.

What is claimed is:

1. An electrolysis apparatus for electrolyzing a metal strip conveyed in one direction, the apparatus comprising a plurality of electrolysis cells arranged in series, wherein:
the metal strip is electrolyzed in an acidic electrolyte by applying an alternating current;
electrolysis is carried out on an electrolytic cell located at a most downstream position, with respect to the conveyance direction, at a lower current density than at an electrolysis cell located upstream, with respect to the conveyance direction, from said most downstream electrolysis cell.

2. The electrolysis apparatus of claim 1, wherein the metal strip is an aluminum strip.

3. The electrolysis apparatus of claim 2, wherein the acidic electrolyte containing as a principal acid component at least one acid selected from the group consisting of sulfuric acid, nitric acid, hydrochloric acid, phosphoric acid and a sulfonic acid.

4. The electrolysis apparatus of claim 2, wherein the alternating current is a sine wave current, a trapezoidal wave current or a rectangular wave current.

5. The electrolysis apparatus of claim 2, wherein the electrolysis cells are vertical electrolysis cells, horizontal electrolysis cells, or radial electrolysis cells.

6. The electrolysis apparatus of claim 5, having at least two electrolytic cells, wherein the ratio of the current density at an upstream electrolytic cell to the current density at a downstream electrolytic cell is from 1.2:1 to 2:1.

7. The electrolysis apparatus of claim 5, wherein the current density at the downstream electrolysis cell is 15 to 30 A/dm².

8. The electrolysis apparatus of claim 5, wherein the apparatus has three or more electrolytic cells.

9. The electrolysis apparatus of claim 8, wherein the density in an electrolysis cell is MC₁, the current density at an electrolysis cell located adjacent to and downstream from one of the said electrolysis cells is MC₂, the current density MC₂ is lower than the current density MC₁.

10. The electrolysis apparatus of claim 5, wherein at least one of the electrolytic cells has a soft-starting portion at an entrance portion thereof from which the aluminum strip is introduced, the soft-starting portion being disposed so that current density increases as the aluminum strip is conveyed farther into the electrolytic cell.

11. The electrolysis apparatus of claim 10, wherein a current density at said soft-starting portion at the entrance is 10 A/dm² or less.

12. The electrolysis apparatus of claim 10, wherein the current density at said soft-starting portion at the entrance portion is in a range of from 1 to 5 A/dm².

13. The electrolysis apparatus of claim 10, wherein said soft-starting portion is formed having a length L calculated according to the following equation:
MC×LS/L=50 to 300
wherein LS is a conveyance velocity at which the aluminum strip is conveyed through the electrolytic cell and MC is the current density at the electrolytic cell.

14. The electrolysis apparatus of claim 10, wherein the soft-starting portion is an asymptotic portion formed at the entrance portion of an electrode of the electrolytic cell, and at which the electrode applies alternating current to the conveyed aluminum strip; said asymptotic portion being formed so as to approach, along the conveyance direction, the conveyance surface on which the aluminum strip is conveyed.

15. The electrolysis apparatus of claim 10, wherein
said electrode is a split-type electrode comprising a group of small electrodes insulated from each other; and
said soft-starting portion is formed by connecting a current reducer to the small electrodes located at the entrance portion of the electrolytic cell.

16. The electrolysis apparatus of claim 15, wherein the current reducer is selected from the group of a resistor and an inductance coil.
